(19) United States
(12) Patent Application Publication
(10) Pub. No.: US 2012/0297363 A1
(43) Pub. Date: Nov. 22, 2012

(54) INFERRED AND SHARED SOURCE CONTROL INTEGRATION ACROSS MULITIPLE PROGRAM DEVELOPMENT TOOLS

(75) Inventors: Marko Perisic, Birkeroed (DK); Lukasz Zoglowek, Gentofte (DK); Vincent Nicolas, Vaerloese (DK)

(73) Assignee: MICROSOFT CORPORATION, Redmond, WA (US)

(21) Appl. No.: 13/111,346

(22) Filed: May 19, 2011

(51) Int. Cl. G06F 9/44

(52) U.S. Cl. 717/122; 717/120

(57) ABSTRACT

An integrated system is provided for synchronizing source code development in an external program development application with source code development in an internal program development environment as a part of a separate Enterprise Management Application (EMA). The integrated system allows for source control operations to be executed in an external program development application and the source control operations to be synchronized with the source code control system contained in the EMA. The source code control system may enable multiple users in a collaborative development environment to modify source code elements on each user's local program development environment, and user modifications may be synchronized with the source control and updated in the source control system to reflect editing status of repository elements in the source control and the latest updated version of a source code element in the source control system repository.

### BACKGROUND

In software development, a single document or segment of code may be edited by a team of users, and the users may be geographically dispersed such that collaboration for editing a document may require multiple versions of a document to be open and edited simultaneously. A version control system (VCS) or a source code control system may provide a way to keep track of the changes and provide the most updated version of a program in the repository by identifying revision numbers and associating revisions with a timestamp and users who made the changes. Source code revisions may be updated by using methods such as file locking and version merging. In a file locking method only one user at a time may have write access to the central repository copies of those files. In version merging, multiple users may edit source code at the same time and the source control system may update the latest version whenever a user checks-in edits and modifications to the source code. In any event, the source code control system may allow a user to check-out a version for editing, creating a local working copy from the repository on the user's local program development environment. The user may then use any program design application (PDA) for making edits to a program.

An enterprise management application (EMA) may be used to create, develop, edit, and manage projects and programs, and the EMA may contain an integrated design environment (IDE) for allowing editing of source code within the EMA environment. In collaborative development of a project, multiple users may have access to the EMA and the IDE for viewing and editing the source code of a project or program in an EMA. Additionally, users may use external program development applications to access, create and edit projects from an EMA. An commonly needed tool in allowing collaboration is having the ability to share and synchronize source code changes using a source control system. If the external PDA and the internal IDE are not integrated into a synchronized system, the source control system may not be able to properly manage edits to source code and track changes for providing the most up to date versions of program source codes. Since external PDAs may be used to edit source code working against the same source control system repository in an internal program development environment, a source control system may need to be able to synchronize modifications to source code made in external PDA's with the source control repository in an enterprise management application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing an integrated system for synchronizing source code development in an external Program Development Application (PDA) with source code development in an internal program development environment as a part of a separate Enterprise Management Application (EMA). The integrated system may allow for source control operations to be executed in an external program development application, and the source control operations may be synchronized with the source code control system contained as part of the EMA. The source code control system may enable multiple users in a collaborative development environment to modify source code elements on each user's local program development environment, and user modifications may be synchronized with the source control and updated in the source control system to reflect editing status of repository elements in the source control and the latest updated version of a source code element in the source control system repository.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 demonstrates an integrated system for synchronizing a program development application with a version control system integrated with an enterprise management application;

FIG. 2 illustrates a screenshot of an example source control menu with available actions according to embodiments;

FIG. 3 illustrates screenshots of example check-out and check-in interfaces of a source code integration system according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of synchronizing source code modifications in an external programming development environment with an integrated source code control system according to embodiments.

### DETAILED DESCRIPTION

As briefly described above, an integrated system may synchronize source code development in an external program development application with source code development in an internal program development environment as a part of a separate Enterprise Management Application (EMA). The integrated system may allow for source control operations to be executed in an external program development application, and the source control operations may be synchronized with the source code control system contained as part of the EMA. The synchronization may enable the external program development applications to interact with the source control contained in an EMA, inferring source control settings and updating the editing status of repository elements in the source control. The source code control system may enable multiple users in a collaborative development environment to modify source code elements on each user's local program development environment, and user modifications may be synchronized with the source control and updated in the source control system to reflect the latest updated version of a source code element in the source control system repository.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing programming tools. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

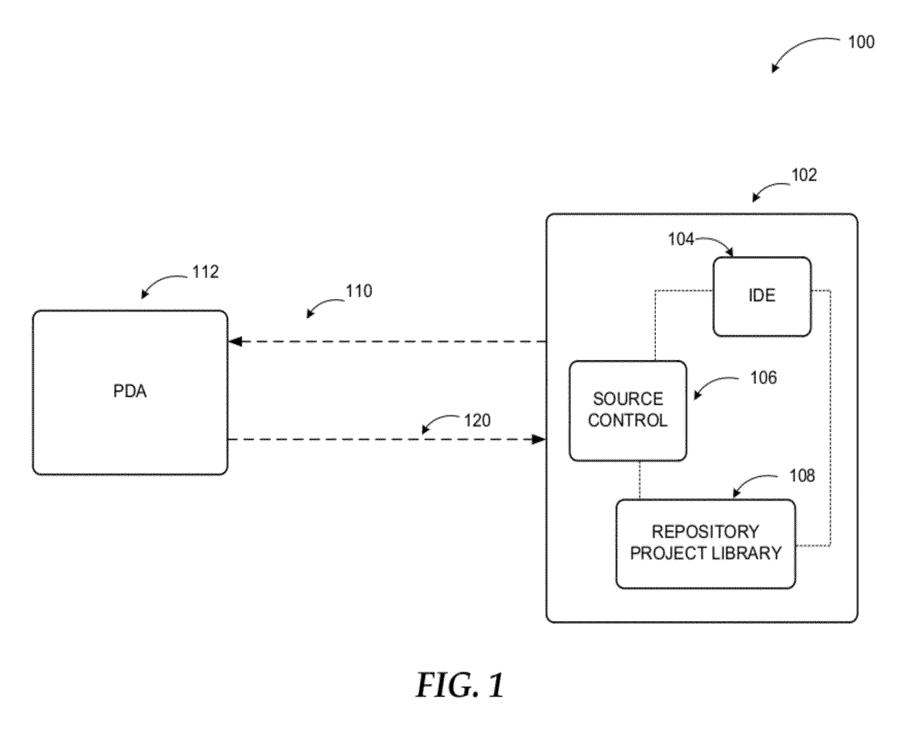

FIG. 1 demonstrates an integrated system for synchronizing a program development application with a version control system integrated to an enterprise management application. In an integrated system according to embodiments, users may have the capability of using external program development applications 112 to design, create and modify programs and projects contained in an enterprise management application (EMA) 102. Frequently, software and program design may be a collaborative effort by a team of users, and multiple users may contribute to the development of source code for programs and projects. Typically, a source control system 106 or a version control system (VCS) may be integrated with the internal development environment (IDE) 104 of the EMA 102 enabling multiple users to edit and modify source codes. The source control system 106 keeps track of when edits are made to the source code, which user makes the edits, and keeps the source code updated with the most recent edits and modifications.

Generally, the source control system 106 may keep the source code updated using a merging method and/or a locking out method. In a locking out method, a user may check-out (110) a source code for editing from the source control repository 108 creating a working copy on the user's local program development environment and locking out other users during editing. Then, when the user checks-in (120) the edited source code from the user's local working copy, the source code changes may be updated into the source control repository 108 for the source code file.

In a system according to embodiments, users may use an internal integrated development environment (IDE) 104 contained within the EMA 102 to edit source code on a project, or a user may use an external program development application (PDA) 112 for building and modifying the source code of an EMA project. When a user opens source code for editing in the internal IDE 104, a source control system 106 may be synchronized with the IDE 104 and may operate to create a local working copy for the editing user, locking out other users from editing the source code while the source code is checked-out for editing. Likewise, in a system according to embodiments, when a user opens source code for editing in an external PDA 112, the PDA 112 may be synchronized through user check-out and check-in (110, 120) with the source control system 106 integrated with the EMA 102 such that interaction between the PDA 112 and the source control system 106 may be essentially the same as interaction between the IDE and the source control system for managing source code edits and updates. Accordingly, when a user opens source code in an external PDA, the external PDA 112 may automatically infer the linking of the source code to the repository of the source control, and may create a local working copy on the user's local external PDA, getting the source code settings from the integrated source control system 106 and configuring itself to work against the source control.

The source control system 106 may additionally lock the source code for editing by other users while the editing user has the source code open on the user's external PDA. Similarly, when the user checks-in (120) the edited source code from the PDA 112 to the source control system 106, the source control system may update the repository 108 with the edited source code producing the most current version of the source code for other users to view and work from. The synchronization of external program development applications with a source control integrated within an EMA 102 may avoid the necessity of a user having to reconfigure the PDA 112 to support a particular source control if the source code has already been configured in another design environment, and create a seamless source code development experience for a collaborative environment of creating and modifying source code for projects and programs in an enterprise management application.

A system according to embodiments may support a variety of source control providers. Some source control systems may have a client/server infrastructure, while other may include local architecture. Local architecture systems may allow a single user system to be set up with less complicated configuration and simpler data back-up such as copying all of the contents of a single directory tree. For multi-user environments, client/server type systems may support atomic commits of multiple files provide shared functionality using direct remote file system access to files in the repository. Thus, users are not constrained to particular types of source control providers and may customize the application and add more providers when needed.

Furthermore, embodiments are not limited to code files. A system according to some examples may support version control system (VCS) operations for modeling elements (e.g., reports) and web controls. These may be stored in version control system repositories as files of a predefined format.

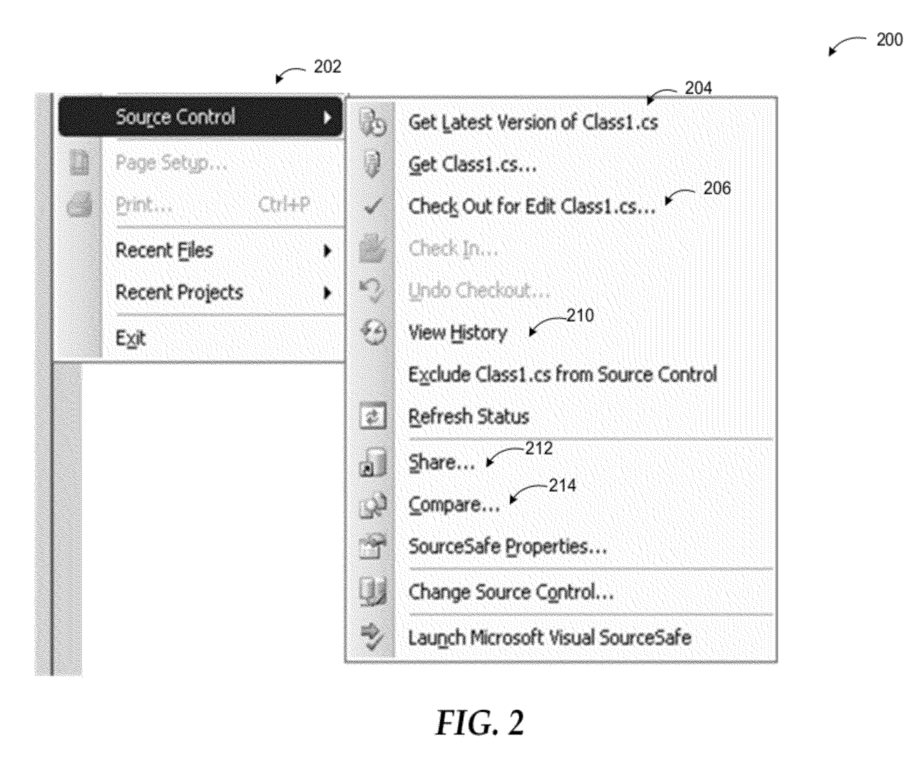

FIG. 2 illustrates a screenshot of an example source control menu with available actions according to embodiments. As demonstrated in diagram 200 a user may use an external program development application to control source code operations for an enterprise management application. For example, in the external PDA environments, operations that may be available for controlling the source code may include view, update, and edit source code for a project from an EMA. Additional operations may include the ability to view editing history of a particular source code, getting the latest version of a source code for editing, renaming an element, reviewing differences in revision versions of a source code, and adding new source code, for some examples.

As demonstrated by the screenshot of example user interfaces in diagram 200, a user may be enabled to employ an external PDA to create a new EMA project for adding to the source control integrated with the EMA. Additionally, the user may build new source code content to add to an existing project contained in the EMA and may add the new source code to the source control repository for the existing project. The user may build the source code content for the new or existing EMA project in a command window of an external PDA, which may be integrated with the EMA for source code control language. In a menu 202 displayed in the external PDA, the user may select the project to which the user is adding source code, and may execute an operation to add the source code to the source control. The external PDA may be synchronized with the source control such that when the user executes to add the code to the source control, the source control repository is seamlessly and concurrently updated to reflect the newly added source control.

When a project has been added to the source control, and the project is subsequently opened using an external program development application, the project may implicitly be enabled for source control synchronization from thereafter. Additionally, any subsequently added elements to the project in an external PDA may also be added to the source control in the enterprise management application. When a user may create a new element in an EMA project using the external PDA, the newly added element may be added to the source control and may appear as checked-out until the editing user commits or checks in the new element to the source control.

In another example embodiment, a user may be enabled to utilize an external PDA in order to get a latest version 204 of one or more source code elements in an EMA project from the source control or to synchronize the changes made in the repository (by other users, for example) into the user's local working copy. The user may open an EMA project for viewing and/or editing in the user's local PDA, and at some point the user may need to update in order to synchronize the latest version of the source code available from the source control with the user's working copy in the user's local program development environment. For example, after a user has opened a project in the PDA, subsequent edits may have been made to one or more source code elements contained in the EMA project by other users. The local editing user may need to update the project in the local external PDA environment to ensure the user is viewing the most recent updates to the source code for the project, for keeping the development efforts of the project unified. After receiving the user's selection of the option to get the latest version 204, the system may automatically retrieve the content of the selected items from the source control system and automatically the local items with the source code content for the project from the source control system. The project in the PDA may be reloaded and the updates may be reflected in the source code in the PDA.

In another embodiment, a user may rename a source code element of a project using an external PDA, and the rename operation may be reflected in the source control such that the name of the element is effectively changed in the source control. The user may identify a source code element for an existing project in the source control that the user desires to rename. In the external PDA, the user may select the source code element to rename, and the source code element may subsequently be loaded into the external PDA, resulting in a “checking out” of the source code element (206) from the source control while the editing user executes a rename operation. While the element is checked-out to the local editing user, the source code may be read-only for all other users and other users may be prevented from editing the source code or the name of the element. Upon executing to rename the element, the external PDA may present a confirmation dialog confirming that the user intends to change the name. Upon confirmation of the name change by the user in the local development environment, the name of the element may be changed in the local PDA and in the source control for the EMA project. Since the PDA environment and the source control are synchronized, the name change operation may occur seamlessly and congruently so that other users in the system may be aware that a source code element has been renamed. Upon successful renaming of an element, the source code element may be checked back in so that other users may have access to that element from the source control for editing.

A user may additionally desire to share 212 edited source code with one or more other users for their review or also to provide editing capability. A user may execute a Share operation (212) in the selection menu of the external PDA and the system may enable the user to select other users who may have access to the source code to view it, or optionally to make edits to it. In this way, an editing user may enable additional users to edit selected source code, though it may be locked out in the source code repository.

In a further example embodiment, other functionalities and operations may be provided in the external PDA for synchronizing with the source control. For example, a user may view the editing history 210 of a particular source code element, including who has edited the source code, when the edits occurred, and what types of modifications were made. Additionally, a user may be able to compare versions (214) of source code elements in the external PDA. For example, a user may be able to view multiple versions concurrently side by side or in the same window for reviewing differences between selected versions and viewing where modifications may have been made by other users to the source code. The user may be able to select which versions the user wants to compare and may select any number of versions to compare in the PDA.

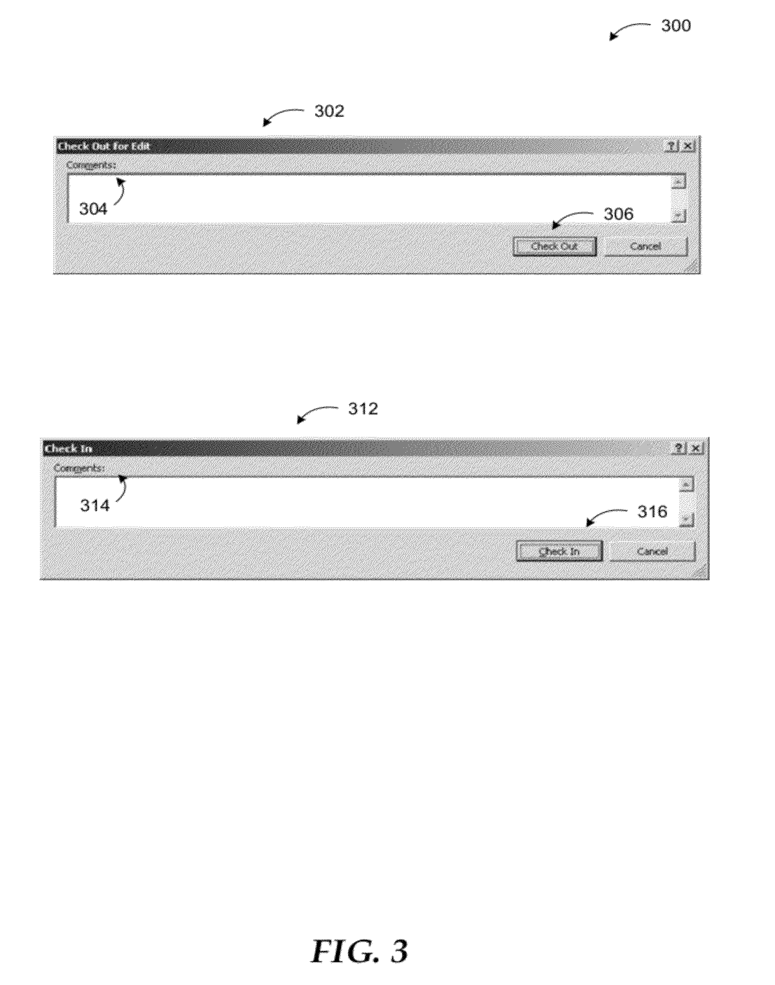

FIG. 3 illustrates screenshots of example check-out and check-in interfaces of a source code integration system according to embodiments. A check-out interface 302 for the source code from the source control using an external PDA may create a local working copy from the source control repository on the editing user's local development environment. The user may specify a specific revision or version or may obtain the latest most updated version for use in the local PDA through additional control elements (not shown) or through a comments box 304. The source code that has been checked-out may then be updated on the user's local program development environment and the system may unlock the items for editing in the user's development environment.

Because the development environments are integrated, the source control may be updated with the checked-out status when a user checks-out source code into an external program development application. When other users try to edit portions of the source code using the EMA's own internal IDE or other external PDAs, the source control may indicate that the source code has been checked-out and is locked for editing by other users. Once a user has checked-out (306) an element file, other users may view read-only versions of the file, but may not make edits to the file until the file is checked-in by the editing user. Upon executing a check-out (306) for editing, a dialog may appear allowing an editing user to add comments in comment box 304 about the source code that the user is checking out for other users to view. When the user executes the check-out, the system may mark the items as checked-out in the source control, and may update the source control with the user comments such that other users may view the comments regarding the source code that the user has checked-out.

Additionally, an undo check-out operation may be available in the external PDA. When a user selects an undo check-out operation in a PDA menu, the system may operate to discard any changes or edits that the user has made to the source code in the user's local development environment. The elements in the source code may be reverted to the version prior to any edits by the editing user since the last check-out. Upon executing the undo check-out operation, the check-out status in the source control may be cleared and the user's changes may be discarded.

As also demonstrated in FIG. 3, a check-in command may be executed on selected elements through a check-in dialog 312. After a user has made edits and modifications to the selected elements in an external development environment, the user may commit or check-in (316) the edited source code to the source control. The check-in may write or merge the changes made in the working copy back into the repository so that the source code is updated with the most recent revisions, and upon checking-in the element, the system may unlock the element for other users to have access to the element in the source control. Upon executing a check-in for editing, check-in dialog 312 may allow the editing user to add comments through comment box 314 about the source code that the user is checking in for other users to view.

Additionally, when the user executes check-in (316), the system may mark the items as checked-in in the source control, and may update the source control with the user comments in comment box 314, and other users may view the comments regarding the source code that the user has checked-in. The system may unmark the elements as checked-out in the source control and allow for other users to check-out the source code elements using their own local program development applications.

The example systems and interfaces in FIG. 1 through 3 have been described with specific elements, applications, and interactions. Embodiments are not limited to systems according to these example configurations. A system for synchronizing source code modifications in an external programming development environment with an integrated source code control system may be implemented in configurations employing fewer or additional components and performing other tasks. Furthermore, specific protocols and/or interfaces may be implemented in a similar manner using the principles described herein.

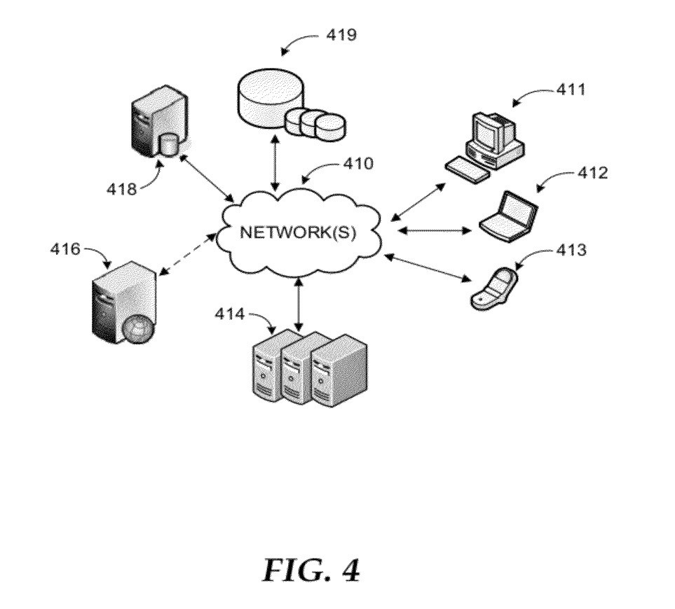

FIG. 4 is an example networked environment, where embodiments may be implemented. A system for synchronizing source code modifications in an external programming development environment with an integrated source code control system may be implemented via software executed over one or more servers 415 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 415, or on individual server 416. An application executed on one of the servers may facilitate synchronizing source code modifications in an external programming development environment with an integrated source code control system. The application may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform for synchronizing source code modifications in an external programming development environment with an integrated source code control system. Furthermore, the networked environments discussed in FIG. 4 are for illustration purposes only. Embodiments are not limited to the example applications, modules, or processes.

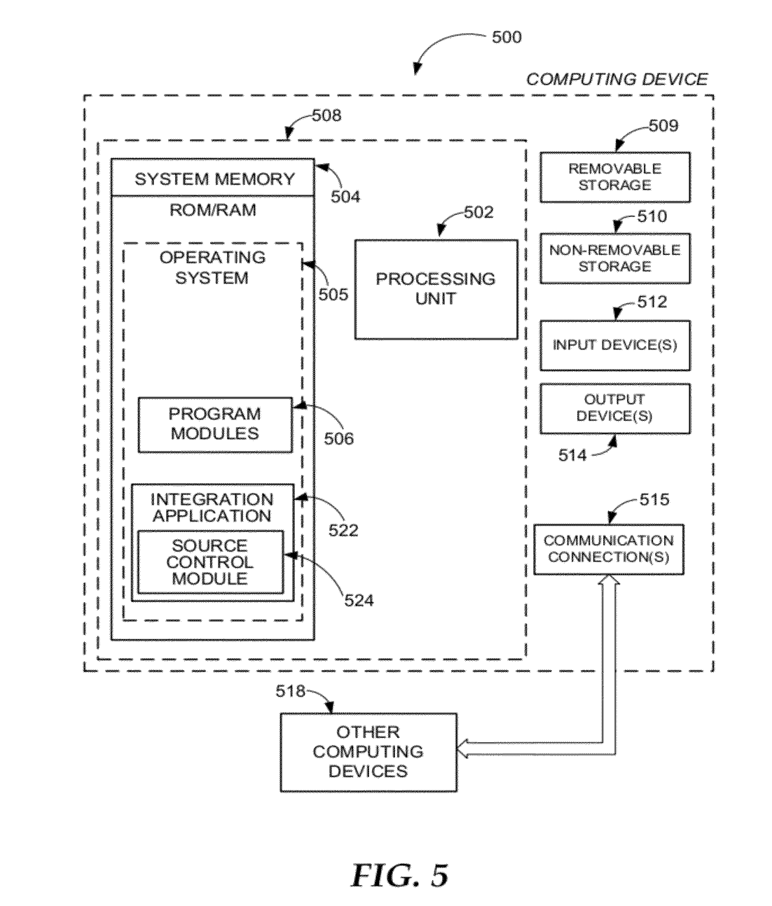

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing one or more applications for programming according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS® operating systems from MICROSOFT CORPORATION of Redmond, Wash. The system memory 504 may also include one or more software applications such as program modules 506, integration application 522, and source control module 524.

Integration application 522 may enable an external program development application to be used to develop and modify source code elements from a project contained in an EMA integrated source code control system. The application may enable the external program development to infer settings and configurations from the source code control system and to load the source code elements into the external program development application command window for modification and editing. Through a source control module 524, the integration application may synchronize modifications and edits made to the source code elements using the external program development applications with the source code elements in the source control system repository, so that the source code control system reflects the most recent edits to a source code element and the most updated version of the source code element for other users within the collaborative environment to access. Application 522 and source control module 524 may be separate application or integrated modules of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

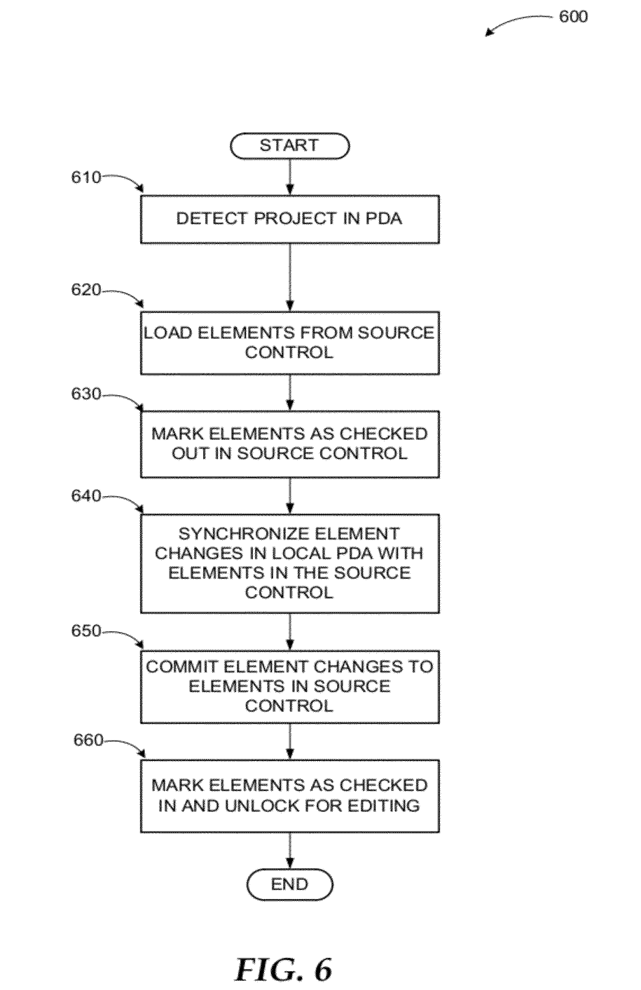

FIG. 6 illustrates a logic flow diagram for a process of synchronizing source code modifications in an external programming development environment with an integrated source code control system according to embodiments. Process 600 may be implemented on a computing device or similar electronic device capable of executing instructions through a processor.

Process 600 begins with operation 610, where the integrated system uses one or more techniques to detect that a user has created a new EMA project in an external program development application or the user has opened an existing EMA project in an external program development application. At operation 620, the system may operate to load source code elements from the source code control system contained in the separate enterprise management application. The system may enable the PDA to infer settings and configurations from the source code control system for loading into the external PDA and may automatically synchronize the source code elements into the external PDA for user modification and development. Additionally, when the source code elements are loaded into an external program development application for editing by a user, the system may create a local working copy on the user's local development environment on which the user may make edits.

While the user is making edits, the original version may be maintained in the source code control system repository until the local editing user submits the edits for updating the elements. At operation 630, the system may determine that source code elements have been checked-out by a user for modification using an external program development application, and the system may mark the source code elements as checked-out in the source control. Additionally, the system may lock out other users from being able to access the source code elements while the source code elements are checked-out by a user in the user's local environment.

At operation 640 the system may synchronize the element changes in the local program development application with the source control system so that the system may reflect the revision history of a source code element. The system may synchronize information such as which edits have been made, which user made the edit, and when the user made the edits. At operation 650, a user may submit the modified source code element to the integrated system by “checking-in” for addition to the source code control system repository. The system may confirm that the user wishes to commit the edited source code element and upon confirmation, the system may update the repository with the newest version of the source code element, containing all of the newly edited source code.

At operation 660, the system may mark the source code elements as “checked-in” at the source control system and may unlock the source code elements so that other users in the collaborative environment may be able to access and further modify the elements using their own local development environments.

The operations included in process 600 are for illustration purposes. An integrated system for synchronizing source code modifications in an external programming development environment with an integrated source code control system may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method for providing an integrated system for synchronizing source control environments comprising:
detecting an external program development application for source code modification;
loading source code elements from a source code control system into the external program development application;
marking source code elements as checked-out in the source code control system;
synchronizing source code operations in the external program development application with the source code control system;
receiving source code element changes at a source code element repository in the source code control system;
updating the source code elements with source code edits executed in the external program development application;
marking the source code elements as checked-in in the source code control system; and
rendering the source code elements available to other users.

2. The method of claim 1, further comprising:
enabling a user to select one or more source code elements from the source code control system for uploading into a project in the external program development application.

3. The method of claim 1, further comprising:
enabling a user to select a version number of a source code element for viewing and updating at the external program development application.

4. The method of claim 1, further comprising:
enabling a user to update the source code in the external program development application with a latest version of the source code from the external program development application.

5. The method of claim 1, further comprising:
enabling a user to view a revision history of one or more source code elements from the source code control system at the external program development application.

6. The method of claim 1, further comprising:
enabling a user to compare two or more versions of source code elements from the source code control system at the external program development application.

7. The method of claim 1, further comprising:
enabling a user to rename one or more source code elements from the source code control system at the external program development application.

8. The method of claim 1, further comprising:
enabling a user to share the source code elements with other users through the source code control system.

9. The method of claim 1, wherein marking source code elements as checked-out at the source code control system further comprises:
creating a local working copy of the source code elements at the user's external program development application;
maintaining an unedited version of the source code element in the repository of the source code control system; and
preventing other users from having editing access to the source code element that is checked-out by enabling a locked-out status.

10. The method of claim 1, wherein marking source code elements as checked-in at the source code control system further comprises:
updating the source code elements in the repository of the source code control system with changes from the local working copy of the source code element on the user's external program development application;
updating a revision history of the source code element; and
disabling a locked-out status and enabling other users to have editing access to the source code element that is newly checked-in.

11. The method of claim 1, further comprising:
enabling a user to undo marking a source code element as checked out;
discarding changes made to the source code element while it was checked-out; and
restoring the source code element in the repository of the source code control system to an unedited version prior to when the source code element was marked as checked-out.

12. The method of claim 1, further comprising:
enabling a user to provide comments regarding one or more source code elements when the source code element is checked-out and checked in;
and displaying the comments in the source code control system corresponding to the source code elements.

13. A computing device for providing integrated system for synchronizing source control environments, the computing device comprising:
a memory;
a processor coupled to the memory, the processor executing an enterprise management application, wherein the enterprise management application is configured to:
detect an external program development application for source code modification;
enable a user to select one or more source code elements from a source code control system of the enterprise management application for uploading into a project in the external program development application;
load selected source code elements from the source code control system into the external program development application;
mark the loaded source code elements as checked-out in the source code control system;
synchronize source code operations in the external program development application with the source code control system;
receive source code element changes at a source code element repository of the source code control system;
update the source code elements with source code edits executed in the external program development application;
mark the source code elements as checked-in at the source code control system; and
render the updated source code elements available to other users.

14. The computing device of claim 13, wherein the enterprise management application is further configured to enable a user to view a revision history of one or more source code elements at the source code control system of the external program development application and to compare two or more versions of source code elements from the source code control system at the external program development application.

15. The computing device of claim 13, wherein the application is further configured to enable a user to rename a source code element at the external program development application and recording the name change at the source code control system.

16. The computing device of claim 13, wherein the application is further configured to:
mark source code elements as checked-out at the source code control system when a user selects one or more source code elements for modifying;
create a local working copy of the source code element on the user's external program development application;
maintain an unedited version of the source code element in the repository of the source code control system;
provide comments in the source code control system by the editing user regarding the checked-out source code; and
prevent other users from having editing access to the source code element that is checked-out by enabling a locked-out status.

17. The computing device of claim 13, wherein the application is further configured to enable a user to select one of a specific revision number of one or more source code elements and a latest version of a source code element for checking-out to the external program development application.

18. The computing device of claim 13, wherein the application is further configured to:
mark source code elements as checked-in at the source code control system when a user submits edited source code elements for commitment to the source code control system;
update the source code element in the repository of the source code control system with the changes from the local working copy of the source code element on the user's external program development application;
provide comments in the source code control system by the editing user regarding the checked-in source code;
update a revision history of the source code element with the updates; and
disable the locked-out status, enabling other users to have editing access to the source code element that is newly checked-in.

19. A computer-readable memory device with instructions stored thereon for synchronizing source control environments in an enterprise management application, the instructions comprising:
detecting an external program development application for source code modification;
loading source code elements from a source code control system of the enterprise management application to the external program development application;
marking the source code elements as checked-out at the source code control system;
preventing other users from having editing access to the source code elements that are checked-out at the source code control system;
synchronizing source code operations in the external program development application with the source code control system;
receiving source code element changes to a source code element repository in the source code control system;
updating the source code elements at the source code control system with source code edits executed in the external program development application;
marking the source code elements as checked-in at the source code control system;
saving a revision history for each source code element at the source code control system; and
enabling the source code elements to be edited by other users.

20. The computer-readable memory device of claim 19, wherein the instructions further comprise:
enabling the user to select one or more source code elements from the source code control system for uploading into a project at the external program development application;
enabling the user to select a latest version of one or more source control elements from the source code control system; and
enabling the user to add source control elements created in the external program development application to the source code control system.
